(19) United States
(12) Patent Application Publication
(10) Pub. No.: US 2007/0085654 A1
(43) Pub. Date: Apr. 19, 2007

(54) PROCESS DEVELOPMENT AND OPTIMIZATION OF EMBEDDED THIN FILM RESISTOR ON BODY

(75) Inventors: Swapan K. Bhattacharya, Cumming, GA (US); Stephen Horst, Atlanta, GA (US); Ioannis Papapolymerou, Atlanta, GA (US); Manos Tentzeris, Atlanta, GA (US)

Correspondence Address: TROUTMAN SANDERS LLP, 600 PEACHTREE STREET , NE, ATLANTA, GA, 30308, US

(73) Assignee: Georgia Tech Research Corporation, Atlanta, GA (US)

(21) Appl. No.: 11/549,792

(22) Filed: Oct. 16, 2006

Related U.S. Application Data
(60) Provisional application No. 60/726,995, filed on Oct. 14, 2005.

(51) Int. Cl. H01C 10/00

(52) U.S. Cl. 338/195

(57) ABSTRACT

The present invention includes an apparatus including a thin film resistor. The thin film resistor includes a resistive component, a body, and a reactant. The resistive component includes a nickel-composite material. The body has a predetermined, sturdy shape. The body carries the resistive component. The reactant manipulates the body to enable the resistive component to adhere to the body.

### CROSS REFERENCE TO RELATED APPLICATION

This application claims priority to U.S. Provisional Patent Application No. 60/726,995 filed 14 Oct. 2005, the entire contents of which is hereby incorporated by reference.

### BACKGROUND

1. Field of the Invention

The present invention relates to resistors and, in particular, to thin film, electrolessly plated resistors and the method of making the same.

2. Description of Related Art

It is often desirable to resist electrical current in a circuit. As a result, most electrical circuits include at least one resistor. Each resistor is adapted to produce a voltage drop between the two terminals of the resistor.

Resistors are well known electrical devices. Conventional resistors are available in two formats, i.e., through-hole or surface-mount. Unfortunately, both resistors consume more surface area of a circuit board than desired. The through-hole resistor not only takes a large amount of space on a circuit board, but also requires a sufficient amount of space above and/or below the board. The surface-mount resistor, though consuming less space than the through-hole, consumes more space than desired. Further, neither resistor format can be embedded in a printed circuit board, because of its large size.

Other examples of resistors or processes of manufacturing resistors have been described in various patents and patent applications. For instance, U.S. Publication No. 2004/0000968 to White et al. discloses an integrated passive device fabricated utilizing multi-layer, organic laminates. These passive devices are fabricated on a circuit board in either surface mount or ball grid array format. White et al. is limited to surface-mount devices and consumes a large amount of a board's surface area.

Another patent application, U.S. Publication No. 2006/0124583 to Kukankis et al. discloses a method for manufacturing a printed circuit boards with a plated resistor. The resistors are plated on an insulative substrate, such that etching and oxidating the board improved the plating process. The plated resistor, however, consumes a larger than desired amount of board surface area.

The resistor is often carried by a body, which provides the necessary structure. Depending on the type of body implemented, the characteristics of a circuit will vary.

All materials, including epoxy and liquid crystal polymer (LCP), have a certain inherent dielectric loss that dampens a time-varying electric field traveling through the material. For example, a sinusoidal current “signal” may be applied to two conductive layers between a given material. A higher frequency signal will have a faster alternating current, which results in a faster alternating electric field. This electric field is present within the material between the two conductive layers. Typically, the faster the field changes, the higher the losses will be based on the dielectric loss property of the given material.

A body comprising epoxy having resistors is known. Unfortunately, epoxy has its limitations because of its inherent dielectric losses. The dielectric losses at frequencies above a few Gigahertz become so restrictive that the material can not be used for high frequency applications.

It is desired to use high frequency substrates, such as liquid crystal polymer, to place a thin film resistor thereupon. Unfortunately, many resistive components do not adhere to high frequency substrates.

What is needed therefore is a thin film resistor that adheres to a body, and a method of making the same. The thin film resistor carried by a high frequency material is also needed. The present invention is directed to an improved resistor and method of making the same.

### SUMMARY

The present invention includes an apparatus having a thin film resistor. The thin film resistor includes a resistive component, a body, and a reactant. The resistive component includes a nickel-composite material. The body has a predetermined, sturdy shape, and carries the resistive component. The reactant manipulates the body to enable the resistive component to adhere to the body.

To accomplish the foregoing and related ends, the following description and annexed drawings set forth in detail certain illustrative aspects and implementations of the invention. These are indicative of but a few of the various ways in which the principles of the invention may be employed. Other aspects, advantages and novel features of the invention will become apparent from the following detailed description of the invention when considered in conjunction with the drawings.

### BRIEF DESCRIPTION OF THE DRAWINGS

FIG. 1 is a cross-sectional view illustrating a thin film resistor layering, in accordance with an exemplary embodiment of the present invention.

FIG. 2 is a flow diagram illustrating a method for making a thin film resistor, in accordance with an exemplary embodiment of the present invention.

FIG. 3 is a top view of a body illustrated after the resistive chemical compound has been etched, in accordance with an exemplary embodiment of the present invention.

FIGS. 4A-4L are cross-sectional views illustrating a layering and etching process, in accordance with an exemplary embodiment of the present invention.

FIG. 5 is a cross-sectional view illustrating a resistive layering from a foil process, in accordance with an exemplary embodiment of the present invention.

FIG. 6 is a flow diagram illustrating a method of making a thin film resistor from a conventional foil, in accordance with an exemplary embodiment of the present invention.

### DETAILED DESCRIPTION

To facilitate an understanding of the principles and features of the invention, it is explained hereinafter with reference to its implementation in an illustrative embodiment. In particular, the invention is described in the context of a thin film resistor and method of making the same.

The invention, however, is not limited to its use as a thin film resistor. Rather, the invention can be used when a thin electronic device is desired, or necessary. Thus, the device described hereinafter as a thin film resistor can also find utility as a device for other applications, beyond that of a thin film resistor. Likewise, the method of making the thin film resistor can also find utility as a method to make other thin film devices.

Additionally, the material described hereinafter as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

Referring now to figures, wherein like references numerals represent like parts throughout the view, the present thin film resistor and method of making the thin film resistor will be described in detail.

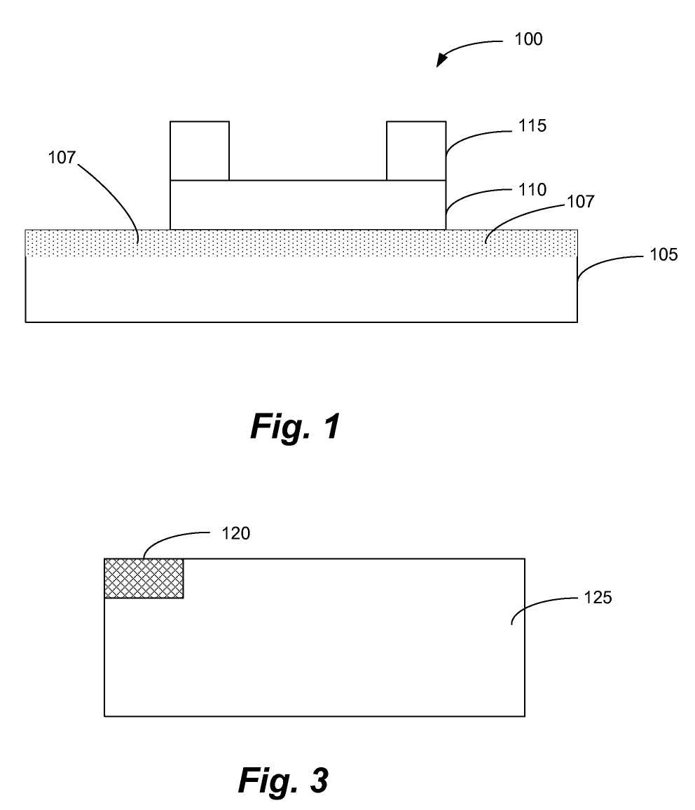

As shown in FIG. 1 a thin film resistor 100 includes a resistive component 110, a body 105, and a reactant 107. The resistive component 110 includes a nickel-composite. The body 105, or carrier, has a predetermined shape and is sturdy enough to carry the resistive component 110. The reactant 107 manipulates, such as roughening up, the body 105 for adhering the resistive component 110 to the body 105. FIG. 1 also shows two terminations 115 in communication with the resistive component 110.

The thin film resistor 100 reduces the amount of space required for a circuit, and operates at tight tolerances while having a known resistance. In fact, the thin film resistor 100 is thin enough to be embedded in a circuit board, such as in a layering of a sandwich printed circuit board. This enables designers to place resistors inside a circuit board (embedded), and also outside on the surface of a circuit board, such as the top and the bottom layers of a single sided or double-sided built-up printed circuit board.

The body (or structure) 105 is sturdy enough to carry the resistive component 110, yet can be flexible enough to be rolled like a thin foil. The body 105 can have a predetermined shape, such as a rectangle, and has a thickness lower than approximately 10 micrometers to act a flexible medium for applications in flexible electronic products. The following is a list, not to be exhaustive but only illustrative, of potential body 105 for the present invention: liquid crystal polymer (LCP), benzocyclobutene (BCB), polymer alloys, polymer blends, polymer dielectrics, epoxy, advanced epoxies, cyanate esters, A-PPE, fire resistant 4 (FR-4), polytetrafluoroethylene (PTFE), modified-PTFE, non-polymeric materials, dielectric materials, organic materials, wood-products, ceramics, silicon wafers, inorganic materials, and the like.

The body 105 may enable frequencies to operate at high frequencies, such as up to 110 GHz. A material that achieves fully integrated system on package (SoP), system on chip (SoC), or system in package (SiP) solutions at radio frequency (RF) and milli-meter wave frequencies includes LCP. Likewise, BCB is a material adapted to operate at high frequencies. Accordingly, high frequency substrates, such as LCP and BCB, are preferred body 105 for the present invention.

Referring now to the resistive component 110, it is a thin layer of resistive material that adheres to the body 105. Resistors can be used for a number of circuits, including for radio frequency circuits, such as terminations, attenuators, power dividers, and stability networks (amplifiers and oscillators). The following is a list, not to be exhaustive but only illustrative, of potential materials for the resistor: nickel phosphorous (NiP), nickel tungsten phosphorous (NiWP), nickel chromium (NiCr), nickel chromium aluminum silicon (NiCrAlSi), chromium silicon (CrSi), chromium silicon oxide (CrSiO₃), resistor alloys, composites, binary compositions, ternary compositions, stochiometric compositions, non-stochiometric compositions, layered composites, conductive thin films, and the like. In an exemplary embodiment, the resistive component 110 includes a nickel-component, such as NiP, NiWP, and other nickel chemical compositions.

The resistive component 110 adheres to, and thus is carried by, the body 105, via the reactant 107. The reactant 107 manipulates the body 105, such as roughens the surface of the body, enabling the resistive component 110 to adhere to the body. Because certain resistive components 110 may not adhere to the body 105, the reactant 107 is necessary for certain body/resistive component combinations. For instance, in an exemplary embodiment, a nickel-composite may not sufficiently adhere to a LCP or BCB body without the reactant.

The termination 115 provides the end points of the resistive component 110, and is adapted to enable a connection to the resistor 110. For instance, connections can be made to vias in a printed circuit board, another layer in circuit board, and/or a connector to a measuring device (such as an oscilloscope), and the like. The terminations 115 can preferably include copper (Cu), although other chemical combination(s) can be included to properly terminate the resistor 110.

The characteristics of the thin film resistor 100 include a resistance between approximately 5 Ohms/square to approximately 100 kilo-Ohms/square, preferably in a range of 5 Ohms/square to 400 Ohms/square. The total thickness of the thin film resistor 100 can be approximately 1,000 to 4,000 Angstrom, while having a tolerance range within approximately 10 to 15%. The thickness, however, can be applied to micro- and nano-scale applications, having approximately 1 to 5% subsequent trim. The temperature coefficient of resistance (TCR) of the thin film resistor 100 can have a range of approximately 0 to approximately 200 ppm/C.

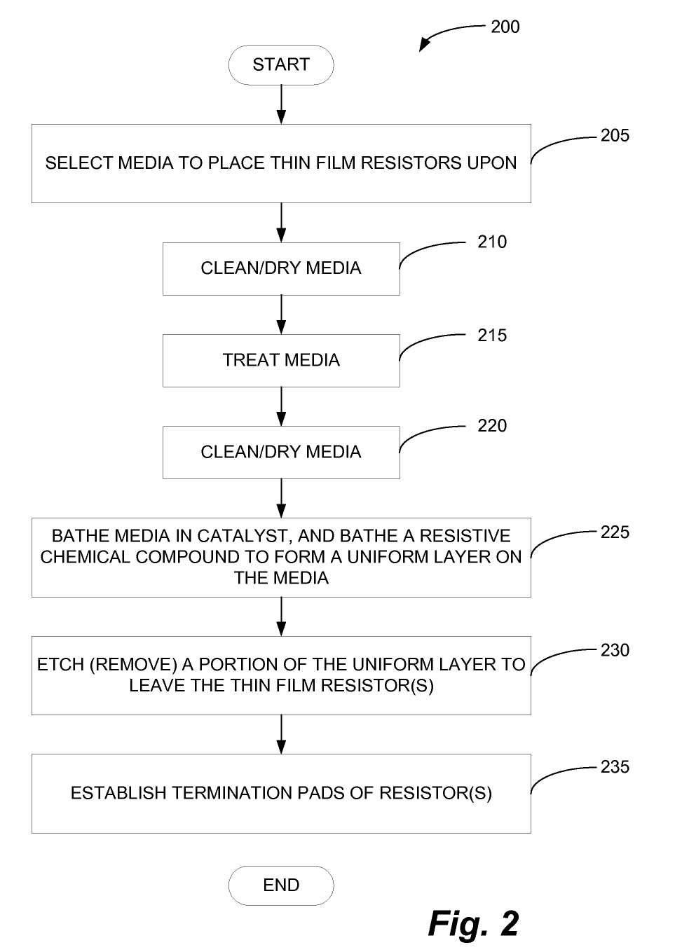

Referring now to the method of making the resistor, an electroless process is provided. The method 200 includes treating the body to enable the adhesion of the resistive component 110 to the body 105, and placing terminations 115 on the resistive component 110. FIG. 2 shows a flow diagram of a method of making the thin film resistor 100.

Method 200 begins at 205 with first selecting the body 105. As described, the body 105 can comprise different materials. The body 105 selected depends on the particular application. Preferably, if the application is the high frequency domain, the body 105 can be LCP or BCB, because of their low dielectric loss at high frequencies.

At 210 the body 105 is cleaned to remove debris, and then is dried. A surface, or the exterior, of the body 105 can be cleaned with different cleaning materials, including but not limited to methanol, ethanol, and/or isopropyl alcohol (IPA). Cleaning can be performed manually, such that an individual scrubs the body 105 with the cleaning material. Or the body 105 can be cleaned by an automated process, i.e., by a machine. The method of cleaning chosen often depends on the volume of body that needs cleaning, such that a high volume of body is preferably cleaned with a machine. As for the drying process, it can be performed by dipping the body 105 in nitrogen or air at approximately 80 C. Like the cleaning process, the drying process can be performed either manually or automatically.

Next, at 215, the body 105 may be treated to develop a chemical activation between the body and the chemical used for the resistor. That is, the body 105 is manipulated to receive the reactant 107. The body 105 can be treated with either plasma (typically a dry gaseous material) or a chemical (typically a liquid material). For example, in a preferred embodiment, if LCP is selected as the body, it can be treated with plasma or chemical, while if BCB is selected as the body, it can be treated with plasma. Depending on the body selected—LCP or BCB—the particular method of preparing the body may vary.

For instance, if LCP is selected as the body, plasma may be selected to treat the body to adhere the resistive component to the body. If plasma is selected, the surface of the LCP should be cleaned, at 210. At 210, the body is treated with methanol, ethanol, and washed in water. Next, the surface of the body is dried at approximately 80 degrees Celsius for approximately 30 minutes. The plasma etching process or treatment, at 215, is conducted with approximately 400 Watts of radio frequency power, at approximately 100 degrees Celsius to manipulate the body. In addition, a gas having a preferred ratio of approximately equal parts of oxygen and carbon tetrafluoride (50/50 ratio) is applied to the surface of LCP for approximately 15 minutes.

Once the surface is cooled, the LCP is cleaned/dried, at 220. This step includes washing the body in water, followed by washing the body in methanol, ethanol. Thereafter, the body is again is washed with water. The LCP is then dried to remove the moisture for approximately 20 minutes at approximately 80 degrees Celsius. The body is then ready for a nickel-composite deposition, or dipping.

If, however, BCB is selected as the body, a different method is performed to prepare the body. The BCB is spin coated on the body. First, an adhesion promoter, such as AP3000, is placed on a pre-cleaned substrate, such as silicon wafer, high temperature FR-4, or alumina ceramic. The adhesion promoter is spun on the substrate at approximately 2000 rpm, for approximately 30 seconds. Then, the coated assembly is baked for approximately 30 minutes at approximately 90 degree Celsius. Second, the spincoated substrate can then be rotated again at 1200 rpm for approximately 30 seconds on the substrate for the BCB coating. Then, the adhesion promoter and BCB coated substrate is baked in a nitrogen atmosphere at approximately 90 degrees Celsius for approximately 30 minutes, then baked at 150 degrees Celsius for 30 minutes, then the temperature is increased to 210 degrees Celsius for approximately 1 hour. After this baking procedure is complete, the substrate is cooled to room temperature. For plasma etching the BCB, a radio frequency of approximately 400 watts is applied at approximately 80 degrees Celsuis. The gas mixture of 40% oxygen and 60% carbon tetrafluoride treats the BCB to enable sufficient adhesion of the resistive component to the body. Preferably, this ratio of the gas mixture is applied to approximately 20 minutes.

Next, the body is washed and cleaned at 220. The body is first washed with water. Then, the body is washed with methanol and ethanol. Afterwards, the body is washed again with water. For 20 minutes at 80 degrees Celsius, the body is then dried. The body is then ready for a nickel-composite deposition, or dipping.

At 225, the body is bathed to form uniform layers on the body 105. Preferably, the bathing, or “dipping” process includes two steps. First, the body 105 is dipped in a catalyst, which is conventional process of catalyzing the surface of the body. Then, the body 105 is dipped in the resistive chemical compound.

The body 105 is first dipped in a catalyst. Preferably, the catalyst is tin and palladium chloride. The catalyst adheres to the body 105 and enables sufficient adhesion of the resistive layer to the body 105.

When the body 105 is dipped in the resistive component 110, a uniform thin film is created around the surface of the body 105. The resistive component 110 can be many different combinations. Some preferred resistive components include NiP, NiWP, NiCr, and the like. Preferably, the resistive component is one batch of the combination of elements. For example, NiP includes both nickel and phosphorus, such that only one dip per body is needed. The type of the resistive component, amount of time the body is dipped in the resistive component, and temperature can affect the thickness, stability, and total resistance of the resistor.

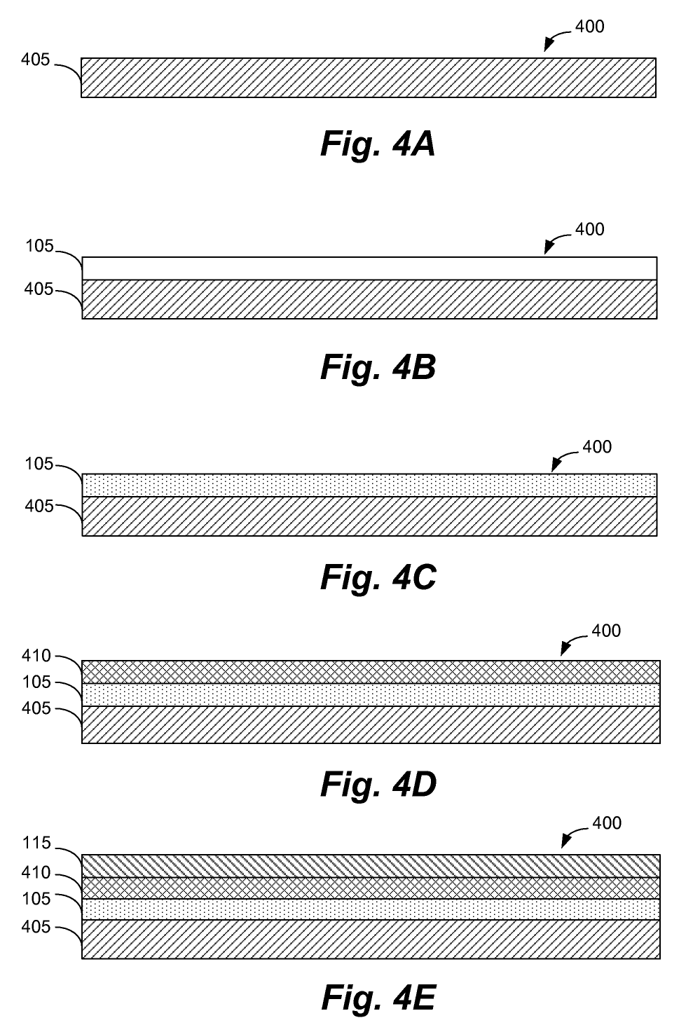

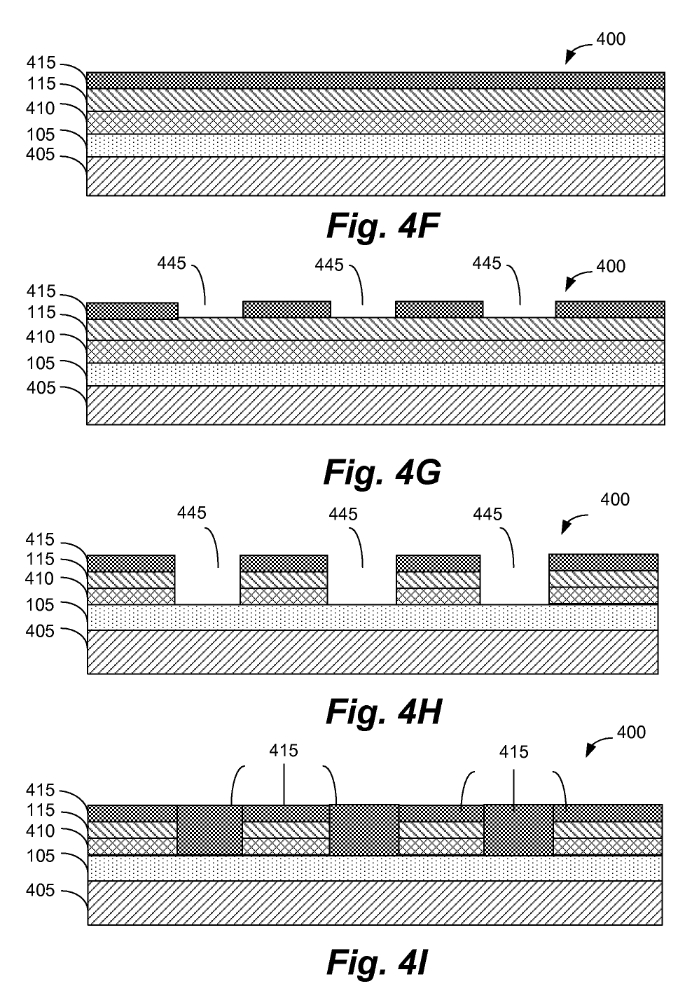

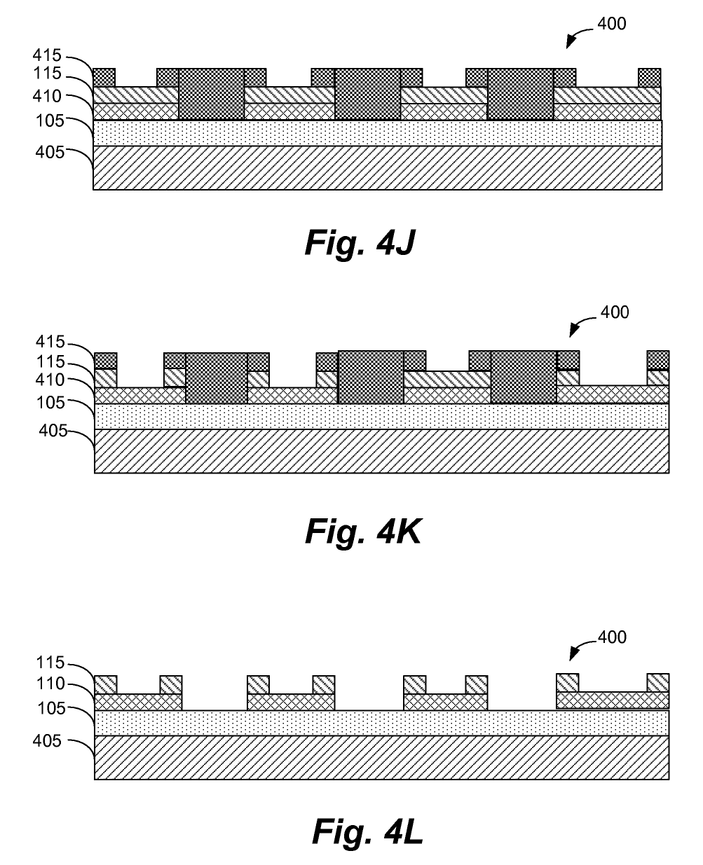

Next, at 230, the resistive component is etched form the resistors in certain areas of the body 105 that are desired. Essentially, a portion of the resistive chemical compound located in predetermined areas of the body is removed. FIG. 3 illustrates a top view of a body, after the resistive chemical compound has been etched. Area 120 is resistive, while the remaining area 125 is the etched (removed) portion on the body 105. FIGS. 4A-4L are cross-sectional view illustrating the layering and etching process.

Referring back to FIG. 2, at 235, the resistor terminations are to be placed on opposing terminal ends of the resistive component. In a preferred embodiment, the terminations 115 are made of copper (Cu), and establish connections between the resistor 110 and another level of a printed circuit, a measuring tool, and the like. Beyond copper (Cu), aluminum (Al), gold (Au), and nickel (Ni) can also be used as the terminations 115 of the resistor 110. The termination, or metalliziation, of resistors occurs through direct copper plating on the resistors 110. Other ways of metallizing resistors include pattern plating, panel plating, etching metal to define pads, and the like, which may require the pre-deposition of a metallic seed layer, preferably copper.

This electroless process or the making of thin film resistors on a nonconductive substrate can occur after the surface of the body is activated with a catalyst. Conventionally, tin chloride (SnCl₂) and palladium chloride (PdCl₂) dissolved in diluted hydrochloric acid (HCl) activate the body 105 to enable adhesion between the resistive component and the body. Acid hypophosphite-based baths are common, because most polymers can withstand low pH. For BCB substrates, however, a different approach may be necessary, because of its smooth surface and chemistry make-up. Exemplary materials that make up the nickel-composite can include Nickel Sulphate (NiSO4), Sodium, Hypophosphite, Maleic Acid, Sodium Succinate, Sodium, Tungstate, and Sodium Citrate.

Because BCB and LCP surfaces are relatively inert, the NiP and NiWP resistors deposited by electroless after conventional swell and permanganate etch treatment may not enable the adhesion of the resistive component to the BCB or LCP surface. Therefore, an alternative (to swell and etch) plasma treatment of the BCB and LCP surfaces using a mixture of CF₄ and O₂ gases is implemented. Ni-composite alloys are initially plated with copper and then patterned to define the resistors with a copper termination. Copper adheres sufficiently to the Ni alloys, while copper electroplating on a Ni surface can control the thickness of copper terminal pads. Preferably, copper is approximately 5 microns to approximately 15 microns thick. The measured sheet resistance values are in the range of approximately 5 Ohms/square to approximately 400 Ohms/square, which sufficiently covers telecommunications, handheld electronic, and computing products. The thickness of the nickel-alloy deposit can be approximately 1000-5000 Angstroms.

FIGS. 4A-4L are cross-sectional views illustrating a layering 400 of the etching process, in accordance with an exemplary embodiment of the present invention. An initial step of the etching process is to select a substrate 405. As illustrated in FIG. 4A, the substrate 105 can be an organic substrate. In a preferred embodiment, the organic substrate 405 can be prepared by baking it at approximately 80° C. for approximately 20 minutes.

Next, as illustrated in a cross-sectional view in FIG. 4B, the substrate 405 can be coated with a material. For instance, the substrate 405 can be deposited with the body 105, for example either liquid LCP or BCB, or can be laminated with a solid film of LCP.

FIG. 4C is a cross-sectional view illustrating the layering 400 of plasma etching the LCP/BCB 105, resulting in a plasma-enriched layer of LCP/BCB 105. This step is to activate the body, such that the body is manipulated, for example the surface is roughened up, enabling the adhesion of the resistive component to the body. This can be accomplished by placing the plasma onto the LCP/BCB 105 at a maximum of 100° C. for approximately 20 to 30 minutes. Subsequently, the LCP/BCB 105 can be cleaned and rinsed with water.

FIG. 4D is a cross-sectional view illustrating the layering 400 having an electroless plating of a resistive component layer 410. In a preferred embodiment, the resistive component is a NiP alloy. Based on pH and temperature controlling, the resistive component layer 410 can have an approximate thickness of 1 um. The thin film resistor 110 will be created from the resistive chemical compound layer 410.

FIG. 4E is a cross-sectional view illustrating the layering 400, such that electroplating copper 115 occurs atop the resistive component layer 410, or the seed layer. Copper 115 can be placed uniformly over the resistive component layer 410 via an acid copper bath. The characteristics of this bath can include 20A/SFT, at approximately 40° C., resulting in a thickness of approximately 12 um.

FIG. 4F is a cross-sectional view illustrating the layering 400, wherein microetching the copper 115. The microetching is accomplished by baking the layering 400 dry, applying a dry film of photoresist 415 application for patterning the resistive chemical compound layer 410. In a preferred embodiment, the dry film photoresists such as FX515 or Riston 4615 can be used.

FIG. 4G is a cross-sectional view illustrating the layering 400, such that using an ultraviolet phototool exposes a portion 440 of the photoresist 415. The layering 400 is then developed and baked dry.

FIG. 4H is a cross-sectional view illustrating the layering 400, after a step of etching the copper layer 115 and resistive chemical compound layer 410 occurred. A portion 445 has been removed from the copper layer 115 and the resistive layer 410.

FIG. 4I is a cross-sectional view illustrating the layering 400, wherein new strips of photoresist 415 are placed in the previously etched holes. Then, the copper layer 115 can be microetched and baked dry. A new dry film of photoresist 415 for patterning the resistive chemical layer 410 can be placed in the layering. This can be accomplished using a photoresist, such as FX515 or Riston 4615.

FIG. 4J is a cross-sectional view illustrating the layering 400 using a second ultraviolet tool to expose a layer of the photoresist 415. After the portion has been removed, the layering is developed and baked dry.

FIG. 4K is a cross-sectional view illustrating the layering 400, such that a portion of the copper 115 has been etched. The copper 115 may be etched using alkaline ammonia. FIG. 4L is a cross-sectional view illustrating the completed etched layering 400. The resistor 110 has termination points of copper 115, and is carried by the body 105, and the photoresists 415 have been removed.

In short, the process etching includes first selecting substrate, and then placing a body onto the substrate. The substrate can then be dipped in a resistive chemical to adhere to the resistive chemical to the body, a photoresist can be placed atop the two layers in order to remove, or etch, a portion of the copper and resistive layers. In the end, resistors are carried by the body, and opposing ends of the resistors include a copper layer for terminations of the resistors.

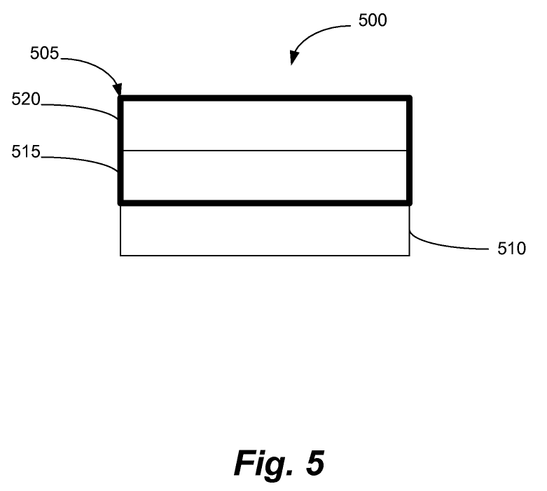

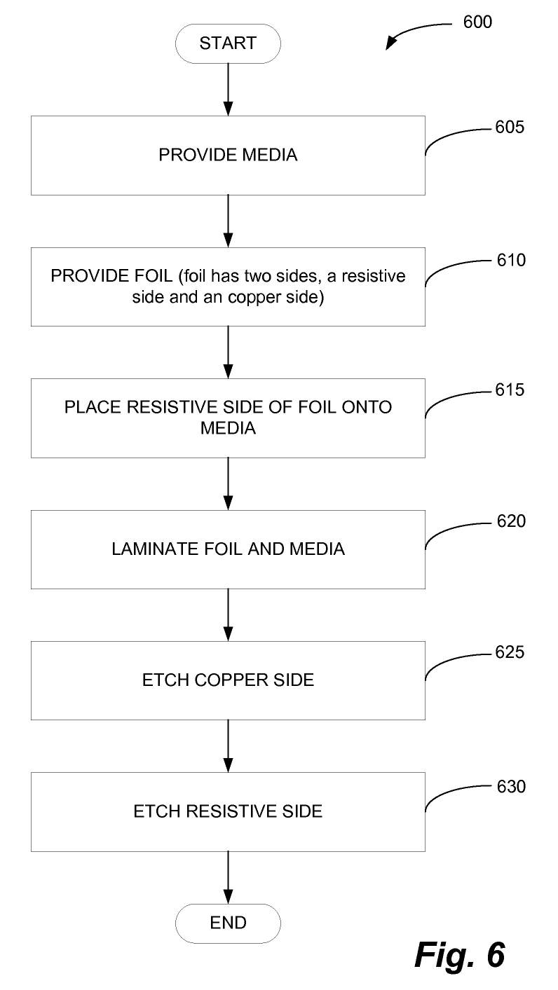

In another embodiment, a conventional foil can be used to create a thin film resistor. FIG. 5 shows a cross-sectional view of a resistive layering from a foil process. FIG. 6 shows a flow diagram of a method of making a thin film resistor from a conventional foil.

An exemplary embodiment, as illustrated in FIG. 5, includes an apparatus 500 that can comprise a double sided resistive foil 505, such that a first side comprises copper 520, and the second side comprises a resistive chemical compound 515; and a body 510 for carrying the double sided resistive foil 505. The double sided resistor foil 505 is commercially available, and commonly used in analog applications.

Having described the apparatus, the method of making the apparatus is shown in a flow chart in FIG. 6. At 605, the body 510 is to be provided. The body 510 can be many different bodies. Preferably, the body 510 includes the high frequency composite substrate, such as either LCP or BCB.

Next, at 610, the foil 505 is to be provided. The foil 505 includes two opposing sides, such that each side includes a different chemical make-up. Preferably, a first side comprises copper 520, while the second side comprises the resistive chemical compound 515. In an exemplary embodiment, the resistive chemical compound 515 can include NiCrAlSi, NiCr, and the like.

At 615, the foil 505 is placed atop the body 510. It is preferred that the resistive chemical compound 515 is placed in communication with the body 510. That is, going from top to bottom, the layering is preferably copper 520, the resistive chemical compound 515, and the body 510.

The apparatus 500 is then laminated, at 620, and the body 510 is laminated to the foil 505.

At 625 and 630, the copper 520 and resistive chemical compound 515 are etched, respectively. This is preferably performed with photoresists. First, photoresists are to be applied on the layer of copper 520. Then, either a selective copper etch is performed, such that only a portion of the copper 520 is removed, or a resistor etch is performed, such that both the copper 520 and resistive chemical compound 515 are removed during the same step.

After a portion of the resistive chemical compound and the copper are etched, the photoresist is removed. A new photoresist is placed over the copper. This may be placed at opposing ends of the resistor, in order to create the terminations. The copper may be selectively removed in the center of the resistive chemical compound, which leaves the copper at the terminating ends, and the resistor exposed in the middle. The result of this etching is shown in FIG. 1.

The present invention includes a new process of electrolessly plating resistors that are formed preferably on either a BCB or LCP dielectric using NiP or NiWP alloy compositions. The electroless plated resistors can act as a seed layer for subsequent copper build up by electroplating, thus forming an resistor/copper foil type of structure, thereby enabling selective etching process to define length and width of resistor patterns on the board. Fine line structures (i.e., <50 μm range) can be fabricated using the NiP and NiWP seeding and a lift-off technique. The deposited resistor films can produce film resistivity in the range of approximately 5 Ohms/square to approximately 400 Ohms/square with good uniformity across the substrate (<10% variation), satisfying the lower resistivity value requirements for mixed-signal applications. This electroless technique allows the use of low cost equipment, tailoring of sheet resistivity and the temperature coefficient of resistance (TCR). Plus, this technique is compatible with a process line of the printing circuit board industry. The films produced may be thin, thereby allow high density integration and circuit miniaturization with the elimination of bulky surface mount resistors. The resulting resistor can be embedded in a circuit board, for the SoP and SiP like applications, or on-chip for SoC and wafer level packaging applications.

The presently disclosed embodiments are, therefore, considered in all respects to be illustrative and not restrictive. The scope of the invention is indicated by the appended claims, rather than the foregoing description, and all changes that come within the meaning and range of equivalents thereof are intended to be embraced therein.

What is claimed is:

1. A thin film resistor comprising:
a resistive component comprising a nickel-composite;
a body having a predetermined shape for carrying the resistive component, wherein the body is sturdy; and
a reactant for manipulating the body to enable the resistive component to adhere to the body.

2. The thin film resistor according to claim 1, further comprising terminations on the resistive component for connecting to other media.

3. The thin film resistor according to claim 1, wherein the body comprises liquid crystal polymer (LCP).

4. The thin film resistor according to claim 3, wherein the reactant is a mixture of equal parts of carbon tetrafluoride (CF₄) and oxygen (O₂).

5. The thin film resistor according to claim 1, wherein the body comprises benzocyclobutene (BCB).

6. The thin film resistor according to claim 5, wherein the reactant is a mixture of approximately 60% carbon tetrafluoride (CF₄) and approximately 40% oxygen (O₂).

7. The thin film resistor according to claim 1, wherein the resistive component has a resistance in the range of 5 Ohms/square to 400 Ohms/square.

8. The thin film resistor according to claim 1, wherein the resistive component comprises nickel phosphate (NiP), nickel tungsten phosphate (NiWP), or nickel chromium (NiCr).

9. The thin film resistor according to claim 1, wherein the body is a layer of a printed circuit board, such that the thin film resistor can be embedded in the printed circuit board.

10. A method for manufacturing a thin film resistor comprising:
providing a body;
applying an reactant for manipulating the body to enable adhesion of a resistive chemical compound to the body;
bathing a portion of the medium in the resistive chemical compound forming a uniform film of the resistive chemical compound on an exterior of the body; and
removing a preselected portion of the resistive chemical compound, wherein the remaining resistive chemical compound comprises at least one thin film resistor.

11. The method according to claim 10, wherein the body comprises liquid crystal polymer or benzocyclobutene.

12. The method according to claim 10, wherein the resistive chemical compound comprises nickel phosphate (NiP) or nickel tungsten phosphate (NiWP).

13. The method according to claim 10, wherein the reactant comprises a gaseous mixture of carbon tetrafluoride (CF₄) and oxygen (O₂).

14. A method of manufacturing a thin film resistor comprising:
providing a body;
introducing the body to a catalyst enabling a nickel-composite to adhere to a surface of the body; and
bathing the body in the nickel-composite, wherein providing a uniform resistive film on the body.

15. The method according to claim 14, further comprising etching a portion of the nickel-composite on the high frequency composite body to create at least one individual resistor on the surface of the high frequency composite body.

16. The method according to claim 15, further comprising inserting terminal pads of the individual resistor for connecting the resistors to another medium.

17. The method according to claim 14, wherein the nickel-composite is from the group consisting of nickel phosphate (NiP), nickel tungsten phosphate (NiWP), and nickel chromium (NiCr).

18. The method according to claim 14, further comprising cleaning the high frequency composite body before introducing the body to the catalyst, and cleaning the body after introducing the body to the catalyst.
